(19) United States
(12) Patent Application Publication
(10) Pub. No.: US 2003/0145127 A1
(43) Pub. Date: Jul. 31, 2003

(54) Method and computer program product for providing a device driver

(76) Inventor: W. Kyle Unice, Sandy, UT (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/037,530

(22) Filed: Jan. 3, 2002

(51) Int. Cl. G06F 13/10

(52) U.S. Cl. 709/321

(57) ABSTRACT

A method of distributing a computer program module is provided. The method includes providing a computer program component and an installation module. The computer program component includes code defining functionality specifically associated with the module and excludes version identification data which is required for the module to execute the functionality under command from a master computer program. The installation module, when run on a computer, obtains the version identification data from the master computer program and combines the version identification data and the computer program component to define the computer program module. The invention extends to a computer program product.

### FIELD OF THE INVENTION

The present invention relates generally to the field of computer program products and, more specifically, to a device driver for a computer.

### BACKGROUND TO THE INVENTION

In computer systems, a device driver is typically used to interface various different software applications to a particular hardware device or peripheral. The driver thus provides an interface to a hardware device so that it can perform functions requested by a variety of different application packages. For example, the applications may be word processors, spreadsheets, web browsers, or the like and the hardware device may be a printer, memory, Universal Serial Bus (USB) port or any other hardware device. In Linux or Unix operating systems, various functional “layers” are typically provided between application programs and various hardware devices or peripherals. The layers interact with the hardware and manages applications is the kernel. The shell loads and executes application programs that the kernel manages. The kernel interacts with the hardware devices via a driver associated with each particular hardware device. Thus, not only must the driver be customized for its associated hardware, it must also be customized for the kernel from which it receives instructions and commands. The kernel typically exports Application Program Interface (API) commands to the driver. In Linux, these API commands include identification data which identifies the version of the kernel. On the other hand, the driver exports a version string to the kernel, the version string defining identification data required to establish a version match between the driver and kernel for operation of the driver with the kernel. Linux Device drivers currently available in the market-place rely on the identification data for proper operation and, when the kernel changes, e.g. a newer version is released, the driver requires updating as well. Thus, even though no new functionality has been introduced to the driver, it still requires recompilation of the device driver source code if the version of the kernel has changed.

### BRIEF DESCRIPTION OF THE DRAWINGS

FIG. 1 shows a schematic block diagram of various functional units involved in interfacing application programs to device drivers;

FIG. 2 shows a schematic block diagram of a prior art driver with its associated kernel;

FIG. 3 shows a schematic flow diagram of prior art steps involved in compiling a new device driver to function with an updated version of a Linux kernel;

FIG. 4 shows a schematic flow diagram of the prior art steps involved in developing and distributing updated device drivers to accommodate Linux kernel version changes;

FIG. 5 shows a schematic flow diagram of a method, in accordance with the invention, of generating a generic kernel version independent device driver component, which can be installed for operation with several different versions of a Linux kernel;

FIG. 6 shows a schematic block diagram of method, also in accordance with the invention, of installing the generic device driver component of FIG. 5;

FIG. 7 shows a schematic flow diagram of a method, also in accordance with the invention, for developing and distributing updated device drivers to accommodate Linux kernel version changes;

FIG. 8 shows a schematic flow diagram of the steps involved from development to installation of a generic device driver in accordance with the invention;

FIG. 9 shows a schematic flow diagram of an exemplary generic device driver before it has been complied; and

FIG. 10 shows a computer system on which the method can be run and the device driver installed.

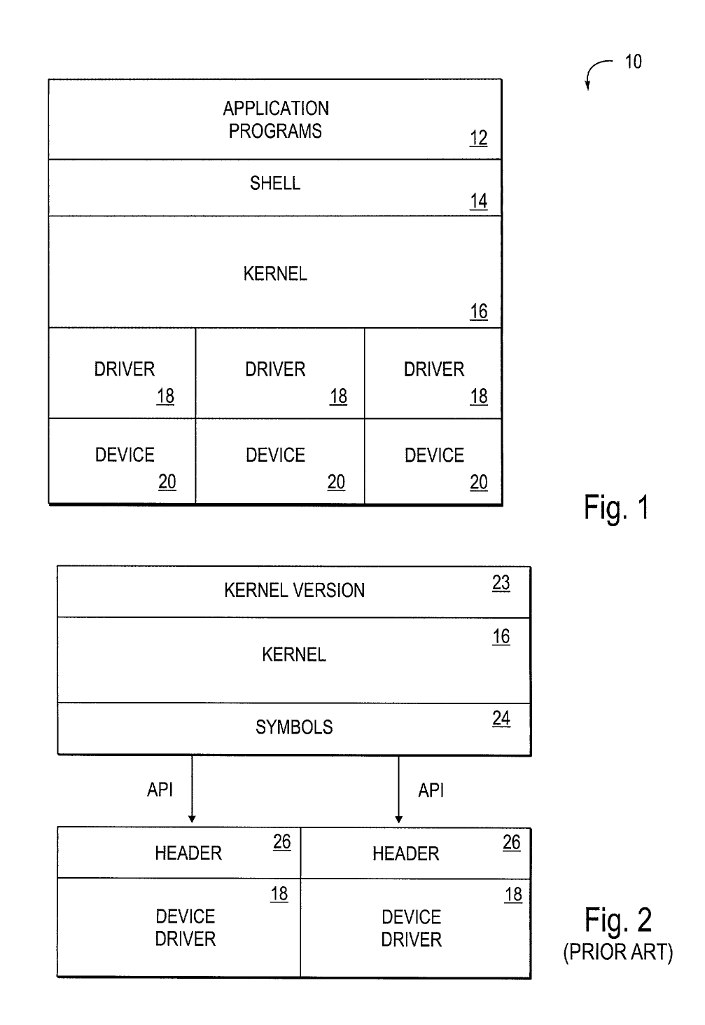

### DETAILED DESCRIPTION OF THE DRAWINGS

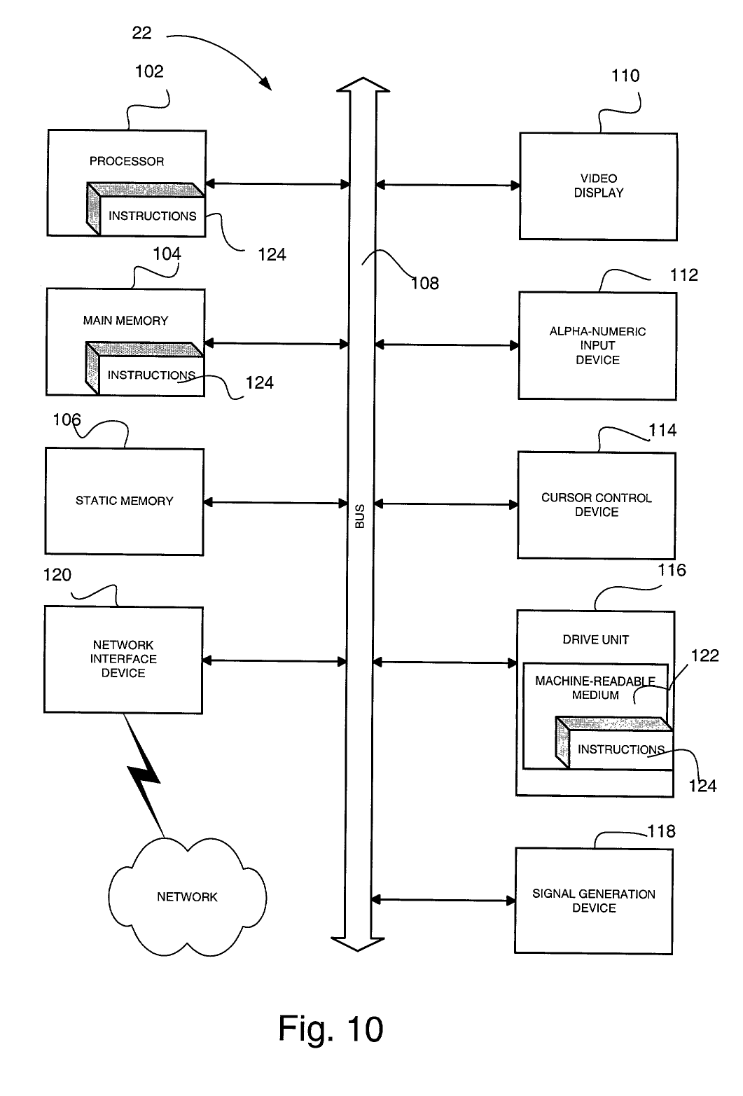

Referring to the drawings, reference numeral 10 generally indicates a functional unit involved in interfacing application packages or programs to device drivers in a Linux environment. The unit 10 includes various applications 12, a shell 14, a Linux kernel 16, device drivers 18, and various hardware devices or peripherals 20 each of which is associated with a specific device driver 18. The applications 12 typically include a word processor, a spreadsheet program, a web browser, or any other application that may be run on a computer system 22 (see FIG. 10). These various applications 12 use common hardware on the computer system 22 and, accordingly, an interface must be provided between the various different applications and each hardware or peripheral device 20. This interface is provided by the kernel 16 that interacts with the applications 12 via the shell 14 and with the devices 20 via the device drivers 18.

The kernel 16 defines the heart of the Linux or UNIX operating system and, under its control, the shell 14 interprets user commands of the application programs 12 whereupon the kernel 16 exports various application program interfaces (APIs) to the relevant device driver 18 for execution. For example, if a user executes an exec command from one of the applications 12, the shell 14 interprets the exec command and communicates it to the kernel 16, which in the Linux environment, then converts the command into a exec kernel API which then effects the execution of a process. Typically, each device 20 is viewed as a file system and the device drivers 18 communicate the data in a binary format to the file system interface via specific APIs. Accordingly, each device driver 18 is typically configured for the specific hardware that it drives and, since the device driver 18 obtains its commands from the kernel 16, the device driver 18 and the kernel 16 must be configured to function with each other.

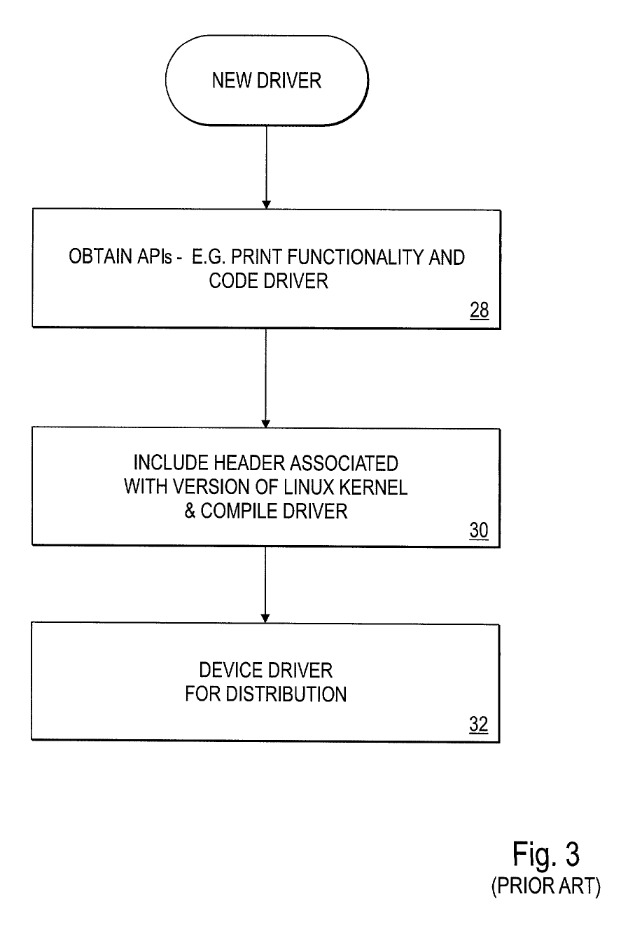

Referring in particular to FIGS. 2 and 3 of the drawings, each kernel 16 has a kernel version 23 that identifies the particular version of the kernel 16. The kernel version 23 has unique symbols 24 which control which version of APIs are exported to device drivers, when compiling a device driver 18, to match a device driver to a specific kernel version a header 26 is included in the compilation of the device driver 18. The symbols 24 are uniquely associated with the kernel version 23 and are used to ensure that the driver 18 only runs on the matching Linux kernel version 23 for which it has been compiled. The device drivers 18, illustrated in FIG. 2 of the drawings, are dynamic device drivers which have not been compiled into the kernel itself but function as stand-alone drivers that are in an object format or .o format and which are run by the kernel 16 when loaded by the administrator of the computer.

If the version of the APIs used in a device driver do not match the version of the APIs exported by the Linux Kernel, the device driver will not dynamically load. A user is then required to obtain the version of the device driver 18 associated with the kernel version 24. This inability to load typically occurs upon release of a different version of Linux. If the developer has released the source code of the particular driver, the user may then obtain the new version of the kernel and recompile the device driver 18 using the new version. However, if the developer has only released the binary version of the device driver 18, the developer would need to code, compile, and distribute a new device driver for operation with the new version of the kernel. In particular, a new driver would be coded with the appropriate functionality as shown at step 28 in FIG. 3, whereafter the driver is then compiled by the developer using the kernel symbols 24 to produce a header 26 (see step 30 in FIG. 3) which corresponds with the particular kernel version 23, thereby generating a new device driver 32 specifically for use with the new version of the kernel. The compiled version of the completed device driver is then distributed.

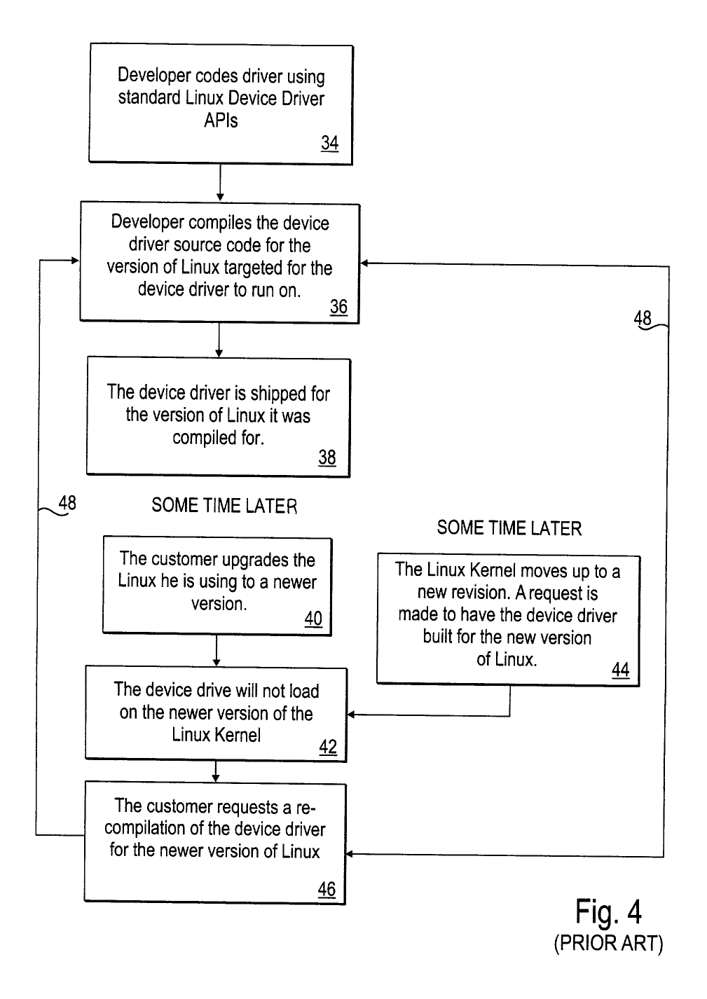

The prior art steps in developing and distributing an updated device driver 18 are shown in FIG. 4. The life cycle of a device driver typically begins when a developer codes the driver using standard Linux driver APIs as shown at step 34. Thereafter, the developer compiles the device driver, as shown at step 36, for the version of Linux targeted for the device driver to run on. In this step, the kernel symbols 24 (see FIG. 2) for the version of Linux targeted are used to define the header 26 of the device driver 18. The product or result of step 36 is a device driver uniquely configured to run with the particular version of the Linux kernel 16 and is provided in a binary file which is then shipped to users for use only with the particular version of Linux for which it was complied (see step 38).

The device driver 18 which has been compiled, as described above, will function on a user's computer system 22 until, for example, one of two events occurs. Firstly, sometime later, the user or customer may upgrade the version of Linux that he or she is currently using on their computer system to a later version as shown at step 40. When the user upgrades the version of Linux running on the computer system 22, the Linux kernel 16 of the latest version is changed to include new kernel symbols 24 which are uniquely associated with the kernel version 23. If the device drivers 18 are not updated as well, when the device driver 18 exports its header 26 including its version string to the kernel 16 with the new kernel version 23, the kernel symbols 24 and the header 26 will not match and, accordingly, the device driver 18 will thus not load on to the new version of the Linux kernel 16 as shown at step 42.

The second situation in which an updated device driver 18 will not load onto the newer version of the kernel 16 is when the Linux kernel 16 itself is updated (see step 44) and it moves to a newer revision, for example, with enhanced functionality. Once again, the kernel symbols 24 will no longer match with the header 26 and, accordingly, as shown at step 42, the device driver 18 will not load onto the newer version of the Linux kernel 16. The customer or user will then be required to request a recompilation of the device driver 18 for the new version of Linux from the developer as shown at step 46. Accordingly, as shown by lines 48 the process reverts to step 36 in which the developer compiles the updated version of the driver for use with a later version of Linux.

Thus, in the prior art, the kernel symbols 24 and the header 26 of the device driver 18 needs to match even if no substantive changes have been made to the device driver 18 or the kernel 16. In fact, the substantive functionality of the device driver 18 may remain unchanged in the prior art but nevertheless require recompilation to generate a new device driver 18 with the modified header 26 in order for a user to ensure operation of the computer system 22 using the Linux operating system.

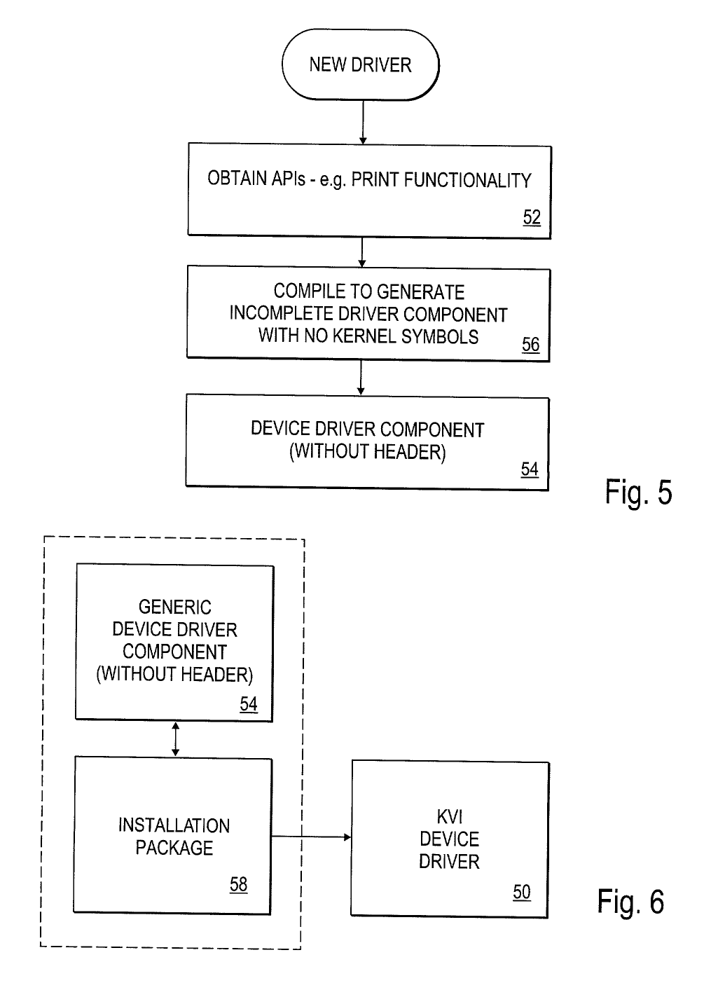

The generic device driver, in accordance with the invention, is configured to operate independent of the kernel version. Referring in particular to FIGS. 5 and 6 of the drawings, when a developer wishes to release a new version of a driver, the functionality for the particular driver is obtained and the various APIs to be included in the driver are coded as shown at step 52. Once the device driver has been coded, the coded driver is then compiled (see step 56) in a different manner to produce a generic device driver component 54 (see FIG. 6) that does not include a header 26 associated with any particular version of a Linux kernel 16. The driver is thus compiled, as described in more detail below, to generate an incomplete generic, and kernel version independent (KVI), driver component 54 in step 56. The incomplete generic device driver component 54 is typically in the form of an object file or .o file and defines a computer program module for use with a master computer program defined by the Linux operating system. Thereafter, the user runs an installation package 58 on the computer system 22 to generate the customized device driver 50 (driver .o). The method of generating the generic, kernel version independent, device driver component 54 and operation of the installation package 58 is described in more detail below.

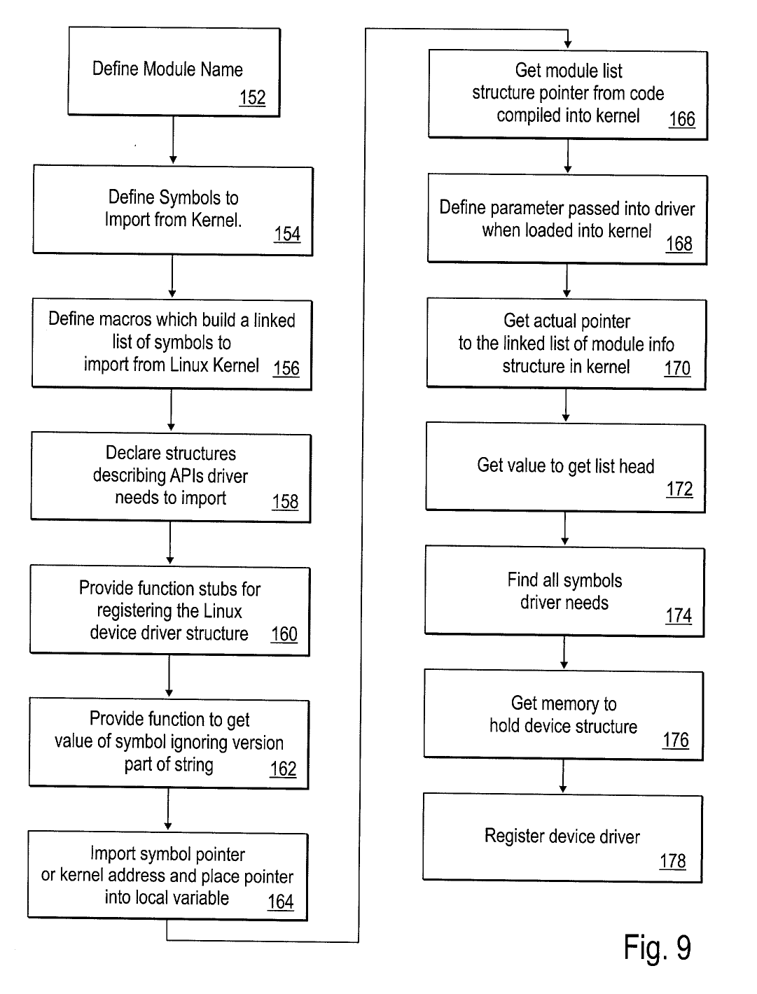

Referring in particular to FIG. 9 of the drawings, reference numeral 150 generally indicates an example of a method, also in accordance with the invention, to produce or generate the driver component 54 that is kernel version independent.

Firstly, the module must be defined, e.g., #define MODULE_NAME “hello” (see step 152).

In this module, most of the headers required for the final customized device driver are included but a version number and its associated symbols are not declared in this or any of the driver object files or .o files. As mentioned above, the kernel symbols 24 associated with the kernel version 23 are compiled into a .o file and linked with this driver (.o file) when the driver is installed on a platform such as the computer system 22.

#define_NO_VERSION_{—}
#include “linux/module.h”
#include “linux/version.h”
#include “linux/config.h”
#include “linux/kernel.h”
#include “linux/types.h”
#include “linux/proc_fs.h”
#include “linux/fs.h”
#include “linux/errno.h”
#include “linux/poll.h”
#include “sym.h”

The following is a list of symbols (see step 154) to be imported for the driver component 54 to function once the installation package 58 has been run. A head and a tail are then defined as follows:

STATIC IMP_SYMBOL *g_ImpListHead;
STATIC IMP_SYMBOL *i_g_ImpListTail = NULL;

Thereafter, the following macros (see step 156) build a linked list of symbols to be imported from the Linux kernel 16 in order to extract its kernel symbols 24 during the build process:

#define IMPORTED_SYM(symb, next) \
STATIC int (*m_##symb)( ); \
STATIC IMP_SYMBOL i_##symb =
{ (IMP_SYMBOL *)&i_##next, 0, #symb,
(void **)&m_##symb, MOD_SYMBOL_FUNC };
#define IMPORTED_SYM_DATA(symb, next) \
STATIC int m_##symb; \
STATIC IMP_SYMBOL i_##symb =
{ (IMP_SYMBOL *)&i_##next, 0, #symb,
(void **)&m_##symb , MOD_SYMBOL_DATA };
#define SET_FIRST(symb) \
g_ImpListHead = &i_##symb

Once the macros have been built, the data structures (see step 158) describing the APIs that the driver needs to import are then declared:

IMPORTED_SYM( printk, g_ImpListTail)
IMPORTED_SYM( kmalloc, printk )
IMPORTED_SYM( kfree, kmalloc )
IMPORTED_SYM( register_chrdev, kfree )
IMPORTED_SYM( unregister_chrdev, register_chrdev )
IMPORTED_SYM_DATA( proc_root, unregister_chrdev )

The following are the function stubs (see step 160) for registering the Linux device driver structure:

```
STATIC loff_t sym_seek( struct file *f, loff_t off, int a)
{ m_printk(“%s: unsupported function %s\n”,MODULE_NAME,
_FUNCTION_);
        return(ENODEV);}
STATIC ssize_t sym_read( struct file *f, char *c, size_t b, loff_t * a)
{ m_printk(“%s: unsupported function %s\n”,MODULE_NAME,
_FUNCTION_);
        return(ENODEV);}
STATIC ssize_t sym_write(struct file *f,const char *c,size_t b,loff_t*a)
{ m_printk(“%s: unsupported function %s\n”,MODULE_NAME,
_FUNCTION_);
        return(ENODEV);}
STATIC int sym_readdir( struct file *f, void *v, filldir_t dir)
{ m_printk(“%s: unsupported function %s\n”,MODULE_NAME,
_FUNCTION_);
        return(ENODEV); }
STATIC unsigned int sym_poll( struct file *f, poll_table *poll)
{ m_printk(“%s: unsupported function %s\n”,MODULE_NAME,
_FUNCTION_);
        return(ENODEV); }
STATIC int sym_ioctl(struct inode *i, struct file *f, unsigned int cmd,
        unsigned long arg )
{ m_printk(“%s: unsupported function %s cmd %d\n”,
MODULE_NAME,
_FUNCTION_, cmd );
        return(ENODEV);}
STATIC int sym_mmap( struct file *f, struct vm_area_struct *vm)
{ m_printk(“%s: unsupported function %s\n”,MODULE_NAME,
_FUNCTION_);
        return(ENODEV);}
STATIC int sym_open ( struct inode *i, struct file *f)
{ m_printk(”%s: unsupported function %s\n”,MODULE_NAME,
_FUNCTION_);
        return(ENODEV);}
STATIC int sym_flush( struct file *f)
{ m_printk(“%s: unsupported function %s\n”,MODULE_NAME,
_FUNCTION_);
        return(ENODEV);}
STATIC int sym_release (struct inode *i, struct file *f)
{ m_printk(“%s: unsupported function %s\n”,MODULE_NAME,
_FUNCTION_);
        return(ENODEV);}
STATIC int sym_fsync( struct file *f, struct dentry *d)
{ m_printk(“%s: unsupported function %s\n”,MODULE_NAME,
_FUNCTION_);
        return(ENODEV);}
STATIC int sym_fasync(int b, struct file *f, int a)
{ m_printk(“%s: unsupported function %s\n”,MODULE_NAME,
_FUNCTION_);
        return(ENODEV);}
STATIC int sym_check_media_change( kdev_t dev )
{ m_printk(“%s: unsupported function %s\n”,MODULE_NAME,
_FUNCTION_);
        return(ENODEV);}
STATIC int sym_revalidate( kdev_t dev )
{ m_printk(“%s: unsupported function %s\n”,MODULE_NAME,
_FUNCTION_);
        return(ENODEV);}
STATIC int sym_lock( struct file *f, int a, struct file_lock *1)
{ m_printk(“%s: unsupported function %s\n”,MODULE_NAME,
_FUNCTION_);
        return(ENODEV);}
STATIC struct file_operations sym_opts =
{
```

```
  sym_lseek,
  sym_read,
  sym_write,
  sym_readdir,
  sym_poll,
  sym_ioctl,
  sym_mmap,
  sym_open,
  sym_flush,
  sym_release,
  sym_fsync,
  sym_fasync,
  sym_check_media_change,
  sym_revalidate,
  sym_lock
```

};

The memory structure of the particular device for which the driver is configured is then defined:

typedef struct sym_dev_s {

int majorNo;

} SYM_DEV;
STATIC SYM_DEV *g_sDev;

The following function (see step 162) obtains a value of a given symbol ignoring the version part of the string:

void *
get_sym_val(

struct module *g_modList,
IMP_SYMBOL *sym)

{

struct module_symbol *ms;
struct module *mp;
for (mp = g_modList; mp; mp = mp->next)
{

int i;
if ((mp->flags & (MOD_RUNNING | MOD_DELETED)) ==

MOD_RUNNING)

for (i=mp->nsyms, ms = mp->syms; i; −−i, ++ms)
{

if (strncmp(sym->name, ms->name, strlen(sym-

>name) )==0)

{

| | |
|---|---|
| // | if (sym->flags & MOD_SYMBOL_DATA) |

| | |
|---|---|
| // | return((void *)*(int*)ms->value); |

return((void *)ms->value);

}

}

}

#ifdef DEBUG

printk(“match failed %s \n”, sym->name );

#endif

return(NULL);

}

The following function (see step 164) iterates through the requested import list and imports each symbol's pointer or kernel address and places that pointer into the local variable (m_*) for use by the kernel version independent driver:

int
setup_import(struct module *g_modList)
{

IMP_SYMBOL *is = g_ImpListHead;
for (;is->next != NULL; is = is->next )
{

*is->myFuncP = get_sym_val(g_modList, is );
if (*is->myFuncP == NULL)
{

#ifdef DEBUG

printk(“%s: unable to import ‘%s’\n”,

MODULE_NAME, is->name );

#endif

return(−1);

}

#ifdef DEBUG

printk(“symbol %s val %x\n”,

is->name, *is->myFuncP );

#endif

}
return(0);

}

The following functions (see step 166) are then carried out to get the module list structure pointer from the code compiled into the kernel. This function first finds an expected byte pattern at the offset (mb) passed in. This is a sanity check to validate that the code for get_module has not changed:

void *get_mod_list( unsigned int mb )
{

unsigned char expect[ ] = {0x83, 0xEC, 0x4, 0x55, 0x57, 0x56,

0x53, 0x8b, 0x1d};

unsigned char *cp = (unsigned char *)mb;
int i;
for (i=0; i<sizeof(expect);i++, cp++)

if(*cp != expect[i])
break;

if (i<sizeof(expect))
{

#ifdef DEBUG

printk(“%s: unexpected byte pattern\n”,MODULE_NAME );

#endif

return NULL;

}
return( (void *) *(int *)cp );

}

The following is a parameter passed into the driver component when it is loaded in the kernel 16 (see step 168). This parameter gives the address of the module list function in the Linux kernel 16. This address is later used to get the head pointer to the module list.

int modBase=−1;
MODULE_PARM(modBase, “1−1i”);
int init_module( void )
{

struct module *g_modList;

Initialize the linked list of symbols that need to be imported from the Linux kernel.

SET_FIRST( proc_root );

Make sure the loader passed in the address of module base as a parameter to this driver.

if ((modBase == 0) | | (modBase==−1))
{

#ifdef DEBUG

printk(“%s: usage: insmod %s.o modBase=<number> \n”,

MODULE_NAME, MODULE_NAME);

#endif

return(EINVAL);

}

The actual pointer is then linked to the linked list of module_info

structures in the kernel (see step 170).

g_modList = get_mod_list( modBase );
if (g_modList == NULL)
{

#ifdef DEBUG

printk(“%s: module list not found \n”,

MODULE_NAME);

#endif

return(EINVAL);

}

Since the instruction is an indirect reference load, the value of what is pointed must be obtained in order to get the list head (see step 172). This may be done as follows:

g_modList = *(struct module**)g_modList;

#ifdef DEBUG

printk(“%s: setting up imports %x \n”,

MODULE_NAME, g_modList );

#endif

The method then finds all the symbols that the driver component needs (see step 174) and also obtains a copy of the data or function pointer into the local variables.

if (setup_import(g_modList))
{

#ifdef DEBUG

printk(“%s: import symbols failed \n”,MODULE_NAME);

#endif

return(EINVAL);

}

Thereafter, memory to hold the device structure for the driver is

obtained (see step 176) and kmalloc indirect call is demonstrated.

g_sDev = (SYM_DEV *)m_kmalloc( sizeof (*g_sDev),
GFP_KERNEL);
if (g_sDev == NULL)
{

m_printk(“%s: alloc failed (size %d) \n”,

MODULE_NAME, sizeof(*g_sDev) );

return(EINVAL);

}

The kernel version independent device driver is then registered (see step 178) using the local register_chrdev function pointer.

if ((g_sDev->majorNo = m_register_chrdev( 0,
MODULE_NAME,

&sym_opts ))

<0)

{

m_printk(“%s: register_chrdev failed \n”,MODULE_NAME);
return(EINVAL);

}

The module has now imported dynamically all needed symbols from the Linux kernel and is ready to operate. It returns success to the device driver loader and prints out some diagnostic info to the console.

m_printk(“%s: got major number %d \n”,MODULE_NAME,
g_sDev-

>majorNo );

m_printk(“%s: hello world \n”,MODULE_NAME);
return(0);

}

Once the above steps have been completed, an unload function is then called when device component is unloaded. The routine cleanup_module is called when the device driver is unloaded. This routine cleans up the device driver structure and does any other “housekeeping” required.

void
cleanup_module( void )
{

If anunload is requested, it could be that all the functions were not imported that were needed to ensure that the local pointers exist before they are used. This step is included as a safety feature.

if (g_sDev)
{

The driver component may then be unregistered using a local indirection function pointer.

if (m_unregister_chrdev)

m_unregister_chrdev( MODULE_NAME,
g_sDev->majorNo

);

g_sDev = NULL;

}

Thereafter, the memory is once again freed with the function pointer defined in the method.

if (m_kfree)

m_kfree( g_sDev );

The process or method is then terminated.
if (m_printk)

m_printk(“%s: goodbye \n”,MODULE_NAME);

}

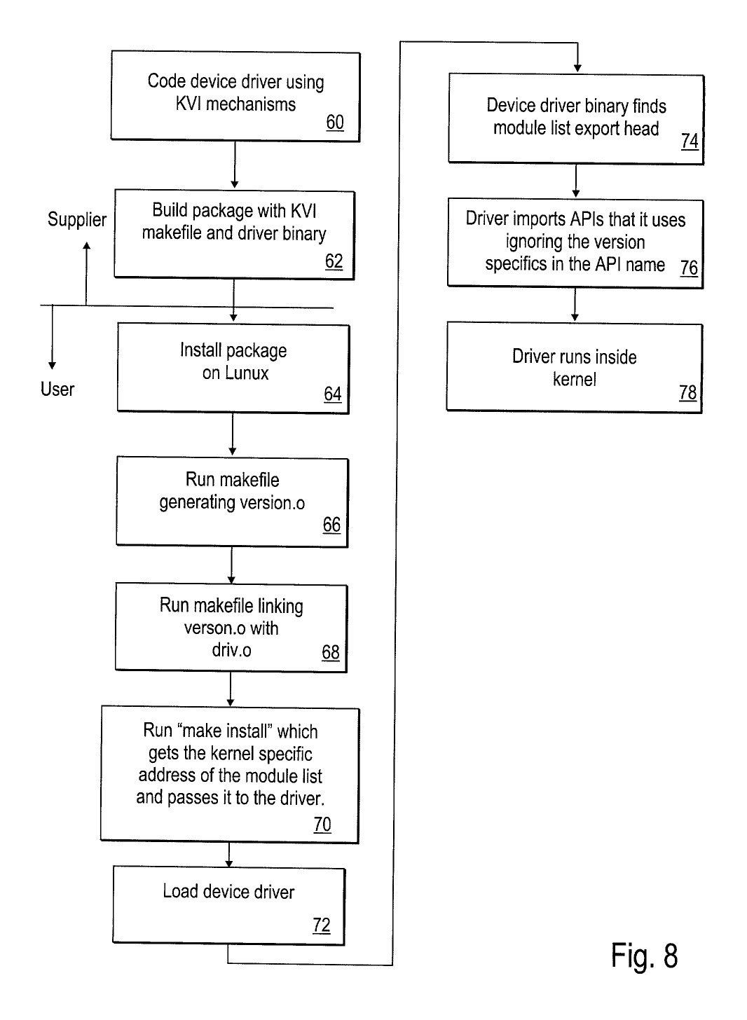

Referring in particular to FIG. 8 of the drawings, the user is provided with the generic device driver component 54 (see step 60) (driver .o) as well as the installation package 58 (see step 62), whereafter the generic device driver component 54 and the installation package 58 are installed on the Linux system (see step 64) of the computer system 22. Thereafter, the user runs a makefile that generates an object file (version .o) associated with the particular version of the Linux kernel 16 on the computer system 22. The makefile is run to link the version.o with the driver.o object files as shown at step 68. During the above-mentioned steps, the installation package 58 links the particular version of the Linux kernel 16 on the computer system 22 with the driver component 54 and runs a make install which gets the kernel specific address (kernel symbols 24) of the module list and passes this to the generic device driver component 54 as shown at step 70 to produce a customized kernel version independent (KVI) device driver 50. The KVI device driver 50 is then loaded on the kernel 16 as shown at step 72, whereafter the device driver binary finds a module list export head as shown at step 74. When the Linux kernel exports commands to the customized device driver 50, the customized device driver 50 imports the APIs that is uses and ignores the kernel version data in the API (see step 76). The customized device driver 50 then runs inside the kernel 16 as shown in step 78.

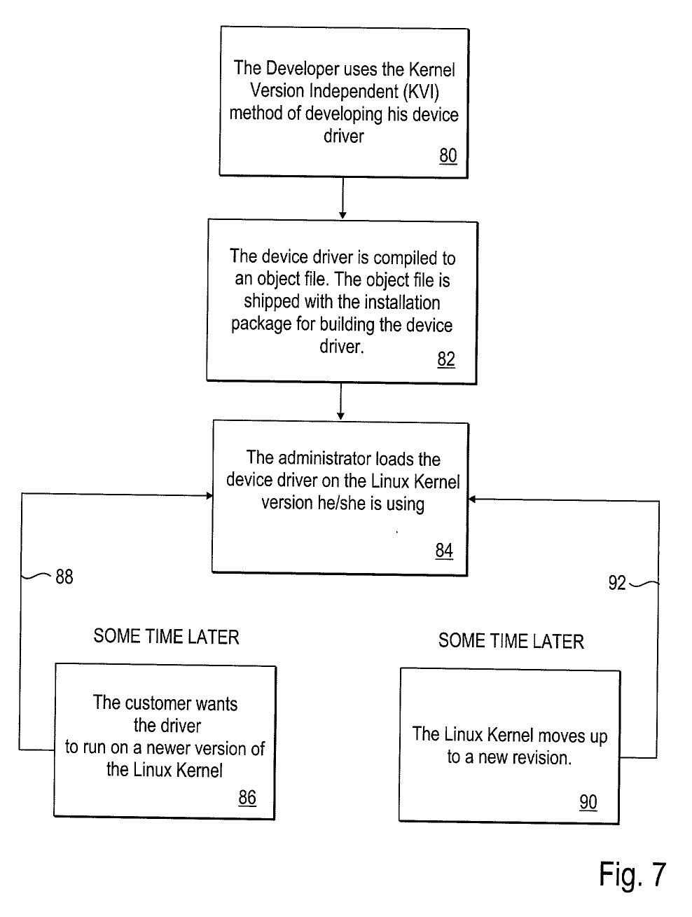

The life cycle of a customized device driver 50 is shown in FIG. 7. The developer uses the kernel version independent (KVI) method (as described above) to generate source code for the device driver component 54 that, as shown in step 82, is then complied to an object file (see step 82) that defines the generic device driver component 54. The device driver component 54, together with the installation package 58, is then shipped or supplied to the users for installation on the computer system 22. For example, a system administrator may load the device driver component 54 and the installation package 58 on to the computer system 22 (see step 84) as described in more detail above with reference to FIG. 8.

An example of the makefile run by the system administrator is described below. The makefile which produces a “c” file to bind in a version string or header 26 with the object file.

CFLAGS = -D_KERNEL_-DMODULE-O-Wall -I.
driv.o : sym.o

echo “#include <linux/module.h>” > version.c
echo “#include <linux/version.h>” >> version.c
gcc $(CFLAGS) -c version.c -o version.o
ld -r sym.o version.o -o driv.o
rm -f version.*

sym.o : sym.c

gcc $(CFLAGS) -c sym.c -o sym.o

clean:

rm -f*.o

install

insmod ./driv.o modBase=0x‘cat/proc/ksyms | grep -i get_module |
cut

-fi -d ″″’

The customized device driver 50 then runs on the computer system 22 in conjunction with the particular version of Linux or Linux kernel loaded on to the computer system 22. If, however, the Linux kernel on the computer system 22 is changed or modified, instead of obtaining a new complied device driver from the supplier, the system administrator or user requiring the customized device driver 50 to run on the newer version (see step 86) merely reverts to step 84 as shown by line 88 and the generic device driver component 54 is then recompiled with the newer version or a modified version of the Linux kernel 16 so that it may once again function in a normal fashion. Likewise, if the Linux kernel 16 is revised (see step 90), the user or administrator merely reverts to step 84 as shown by line 92 where the customized device driver 50 is then recompiled from the device driver component 54 using the installation package 58.

Since the customized device driver 50 can import an API irrespective of the version of the kernel supplying or exporting the API, it is possible that an API function may have changed and that the user may attempt to load a driver which is no longer current. In order to avoid this situation, a programmer or user may check the APIs that are being imported against the source code for the Linux kernel that is to be run on the computer system 22 to ensure that no substantive changes to the driver functionality have taken place.

In summary, all the APIs exported by the Linux kernel 16 are contained in a module list within the kernel itself. As described above, the KVI model requires accessing the list of APIs so that it can import them into the incomplete device driver component 50. This requires finding the virtual address of the module list when the driver loads. This is typically done in the /proc/ksyms file which is searched for the symbol of a function known to use a particular module list. This function pointer is then passed to the driver when it loads. The KVI device driver 50 then scans through the binary code and extracts the pointer to the module list.

As discussed above, the Linux kernel generally exports APIs, e.g., printk, register_int, or the like, for use by the device drivers 18. These APIs may change from release to release of the Linux kernel 16 and, in each release, the Linux kernel 16 appends a date and time stamp at the end of the APIs to guarantee that the device driver using an API uses the right version of that API. For example, the 2.2.16 version of the Linux kernel 16 exports the printk API as “printk_R1b047e0d” wherein R16047e0d defines the kernel symbols 24. When a conventional driver is compiled that uses the printk API, a header is included that changes the API imported by the device driver to “printk_R1b047e0d”. As a result, the driver is compatible only with the 2.2.16 version of the Linux kernel 16 and the driver binary can only load or be linked with a corresponding or associated Linux 2.2.16 version. When a later version comes out e.g., a version for the 2.4.0 the driver will need to be recompiled by the supplier with the header 2.4.0 version so that the driver may link with or load onto the 2.4.0 version of Linux. The device driver component 54 dynamically imports the header allowing the KVI device driver 50 to run with the newer version.

FIG. 9 shows a diagrammatic representation of a machine in the exemplary form of the computer system 22 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 22 includes a processor 102, a main memory 104 and a static memory 106, which communicate with each other via a bus 108. The computer system 22 may further include a video display unit 110 (e.g., a liquid crystal display (LCD) or a cathode ray tube (CRT)). The computer system 22 also includes an alphanumeric input device 112 (e.g., a keyboard), a cursor control device 114 (e.g., mouse), a disk drive unit 116, a signal generation device 118 (e.g., speaker) and a network interface device 120.

The disk drive unit 116 includes a machine-readable medium 122 on which is stored a set of instructions (software) 124 embodying any one, or all, of the methodologies described above. The software 124 is also shown to reside, completely or at least partially, within the main memory 104 and/or within the processor 102. The software 124 may further be transmitted or received via the network interface device 120. For the purposes of this specification, the term “machine-readable medium” shall be taken to include any medium which is capable of storing or encoding a sequence of instructions for execution by the machine and that causes the machine to perform any one of the methodologies of the present invention. The term “machine-readable medium” shall accordingly be taken to included, but not be limited to, solid-state memories, optical and magnetic disks, and carrier wave signals.

Thus, a method and system for providing a kernel version independent device driver has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

[image]

[image]

What we claim is:

1. A method of distributing a computer program module, the method including
distributing a computer program component which includes code defining functionality associated with the module and excludes version identification data for the module to execute the functionality under command from a master computer program; and
distributing an installation module which, when run on a computer, obtains the version identification data from the master computer program and combines the version identification data and the computer program component to define the computer program module.

2. The method of claim 1, in which the master computer program is an operating system and the computer program module is a device driver, the master computer program being identifiable by the version identification data.

3. The method of claim 2, in which the operating system is one of a Linux and a UNIX-, operating system.

4. The method of claim 3, in which the functionality included in the computer program component allows the computer program module to execute an application program interface (API) exported from the master computer program.

5. The method of claim 3, which includes compiling the computer program component into an object file prior to distribution of the computer program module.

6. The method of claim 5, which includes obtaining version identification data from the operating system and generating a version object file that includes the identification data.

7. The method of claim 6, which includes linking the version object file and the computer program component.

8. The method of claim 7, which includes obtaining a kernel specific address of a module list and passing the address to the computer program module.

9. The method of claim 2, in which the device driver is one of a printer driver, a serial port device driver, an ethernet device driver, and a disk drive device driver.

10. The method of claim 1, in which the installation module forms part of the computer program component.

11. A computer program product including a medium readable by a computer, the medium carrying instructions which, when executed by the computer, cause the computer to:
identify a computer program component which includes object code defining functionality associated with the product and excludes version identification data for the product to execute the functionality under command from a master computer program;
obtain the version identification data from the master computer program and combine the version identification data and the computer program component to define a computer program module; and
store the computer program module in memory.

12. The product of claim 11, in which the master computer program is an operating system and the computer program module is a device driver, the master computer program being identifiable by the version identification data.

13. The product of claim 12, in which the master computer program is one of a Linux and a UNIX, operating system.

14. The product of claim 13, in which the functionality included in the computer program component allows the computer program module to execute at least one application program interface (API) exported from the master computer program.

15. The product of claim 14, which includes obtaining version identification data from the operating system and generating a version object file that includes the version identification data.

16. The product of claim 15, which includes linking the version object file and the computer program component to generate an object file that defines the computer program module.

17. The product of claim 16, which obtains a kernel specific address of a module list and passes the address to the computer program product.

18. The product of claim 17, in which the computer program product retrieves a module list export head and imports the required application program interfaces (APIs) ignoring the version identification data.

19. The product of claim 13, in which the device driver is dynamically loaded in a Linux kernel.

20. The product of claim 11, in which the installation module forms part of the computer program component.

21. A computer program product including a medium readable by a computer, the medium carrying instructions which, when executed by the computer, cause the computer to:
define symbols to be imported from a Linux kernel, the symbols being uniquely associated with a particular version of the Linux kernel and used by the computer program product which operatively defines a device driver;
declare structures that describe application program interfaces (APIs) to be imported from the Linux kernel for operation of the device driver;
obtain the symbols that define identification data from the Linux kernel;
combine the symbols with driver code functionality provided by the computer program product; and
dynamically import the device driver in the Linux kernel.

22. The product of claim 21, which defines macros that build a linked list of the symbols to be imported from the Linux kernel.

23. The product of claim 21, which defines function stubs for registering the device driver.

24. The product of claim 21, which defines a memory structure of a particular device for which the device driver is configured.

25. The product of claim 24, which iteratively imports each symbol's kernel address and places the address into a local variable for use by the device driver.
